(19) United States
(12) Patent Application Publication
(10) Pub. No.: US 2026/0335826 A1
(43) Pub. Date: Oct. 29, 2026

(54) CARBON SEQUESTRATION USING BYPRODUCT BRINES

(71) Applicant: ExxonMobil Technology and Engineering Company, Spring, TX (US)

(72) Inventors: Corey J. KAMINSKY, Maplewood, NJ (US); David O. MARLER, Easton, PA (US); Sanket K. DESAI, Katy, TX (US); Emiel DE SMIT, Brussels (BE)

(21) Appl. No.: 19/562,117

(22) Filed: Mar. 10, 2026

Related U.S. Application Data
(60) Provisional application No. 63/793,183, filed on Apr. 23, 2025.

(51) Int. Cl. B01D 53/62; B01D 53/14; B01D 53/78; C01F 5/14; C01F 5/24; C01F 11/18; E21B 41/00

(52) U.S. Cl. CPC B01D 53/62; B01D 53/1418; B01D 53/1475; B01D 53/1493; B01D 53/78; C01F 5/14; C01F 5/24; C01F 11/18; C01F 11/187; C01F 11/188; E21B 41/0064; B01D 2251/2065; B01D 2251/304; B01D 2251/306; B01D 2251/604; B01D 2252/60; B01D 2257/504; B01D 2258/06

(57) ABSTRACT

A composition, apparatus, and method for enabling improved carbon sequestration. An exemplary embodiment provides an apparatus for carbon sequestration. The apparatus includes a carbonate solid generator to receive carbon dioxide, a byproduct brine, and a base additive. The carbonate solid generator can mix the carbon dioxide, the byproduct brine, and the base additive to precipitate a carbonate solid. The carbonate solid generator can separate the carbonate solid from the mixture. The carbonate solid generator can sequester the carbonate solid.

### CROSS-REFERENCE TO RELATED APPLICATION

This application claims priority to and the benefit of U.S. Provisional Application No. 63/793,183, entitled “CARBON SEQUESTRATION USING BYPRODUCT BRINES,” having a filing date of Apr. 23, 2025, the disclosure of which is incorporated herein by reference in its entirety.

### FIELD

The present techniques generally relate to sequestration of carbon dioxide. More specifically, the present techniques are directed towards methods and apparatuses for sequestering carbon dioxide using byproduct brines.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Carbon dioxide is currently being extracted from the Earth's atmosphere via various means. In order to prevent its release back into the atmosphere, such captured carbon dioxide needs to be effectively sequestered.

Some methods of sequestration use calcium or magnesium sourced from seawater to react with the gaseous carbon dioxide and thus generate carbonate solids. However, the usage of cations from seawater for purposes of sequestration may actually release carbon dioxide back into the air from the ocean. For example, the calcium and magnesium found in ocean water may already be serving to sequester carbon dioxide in seawater and thus carbon dioxide may be released back into the air from the water if such calcium or magnesium is removed. Thus, although the captured carbon dioxide is sequestered, the overall amount of carbon dioxide in the atmosphere may not decrease in the same amount. An improved process of carbon sequestration is desirable.

### SUMMARY

An exemplary embodiment provides an apparatus for carbon sequestration. The apparatus includes a carbonate solid generator to receive carbon dioxide, a byproduct brine, and a base additive. The carbonate solid generator is to mix the carbon dioxide, the byproduct brine, and the base additive to precipitate a carbonate solid. The carbonate solid generator is to further separate the carbonate solid from the mixture. The carbonate solid generator is to also sequester the carbonate solid.

Another exemplary embodiment provides a method of sequestering carbon. The method includes receiving captured carbon dioxide, a byproduct brine, and a base additive. The method also includes mixing the dioxide, the byproduct brine, and the base additive to precipitate a carbonate solid. The method also further includes separating the carbonate solid from the mixture. The method also includes sequestering the carbonate solids.

These and other features and attributes of the disclosed embodiments of the present disclosure and their advantageous applications and/or uses will be apparent from the detailed description that follows.

### BRIEF DESCRIPTION OF THE DRAWINGS

The advantages of the present techniques are better understood by referring to the following detailed description and the attached drawings, in which:

FIG. 1 is a block diagram of an apparatus for the sequestration of carbon dioxide from a hydrogen production system using a brine, according to embodiments herein;

FIG. 2 is a schematic diagram of a process for the sequestration of carbon dioxide using a brine, according to an embodiment; and

FIG. 3 is a process flow diagram of a method for sequestering carbon dioxide, according to an embodiment.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, bromine, iron, boron, silicon, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a direct lithium extraction (DLE) process or from subsequent refinement processes on the DLE eluate or reject stream streams.

The term “deep subsurface brine” refers to a saline solution that has circulated through rocks deep in reservoirs such as those found in East Texas, North Dakota, and Arkansas in the United States, and in Alberta, Canada.

The term “divalent” refers to an element having two valence electrons. Example divalents discussed herein include calcium and magnesium.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “filter train” refers to a series or sequence of multiple filtration stages or units arranged in a specific order to remove particulate matter, impurities, or other undesirable substances from a fluid stream. The filter train involves using a step-by-step approach to filtration, with each stage designed to target specific particle sizes or types of contaminants. The goal may be to achieve a high level of filtration efficiency and ensure that a final product meets required quality standards.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, the term “monovalent” refers to an element having one valence electron. Example monovalents discussed herein include sodium, potassium, and lithium.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables from 50% to greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfide (H₂S). The present technological innovation generally relates to compositions for preventing sorbent poisoning and pipe corrosion. These techniques generally relate to treated brine compositions with reduced concentrations of H₂S that can also be used for recovery of metals, including lithium, manganese, rubidium, cesium, and potassium.

DLE can be integrated with other technologies for production of lithium product. For example, such technologies may include a precipitator, nanofiltration, reverse osmosis, ion-exchange polishing resins, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

In various examples, the output of a DLE unit may be input into various other units for conversion of the stream into lithium. However, the various components of the conversion process may produce byproduct streams that may include amounts of divalents that are typically reinjected into the reservoir.

One means of sequestering carbon dioxide involves converting the carbon dioxide from a gas into a solid state via precipitation. For example, cations such as calcium (Ca), magnesium (Mg), barium (Ba) and strontium (Sr), among others, form stable, insoluble carbonate salts when they react with gaseous carbon dioxide at elevated pH levels. CO₂ mineralization thus requires a source of metal cations and oxide equivalents in order to form the carbonate minerals that contain CO₂ in a stable, sequestered form. Deep brines from the Smackover region contain large amounts of divalent ions that can sequester CO₂ in the form of stable carbonate minerals but only if the pH of the stream is increased through addition of base. For example, such pH levels may be 6 or above.

Accordingly, embodiments described herein enable improved carbon sequestration using processed brines from deep subsurface brines, among other sources of brine. In one embodiment, a sequestration process is described with a byproduct brine stream that increases the percentage of carbon dioxide that is sequestered. An associated processed brine composition for improved carbon dioxide sequestration is also described. The use of such a processed brine composition may enable increased carbon dioxide storage by completely avoiding the use of divalents from ocean water, thus decreasing the amount of carbon dioxide that would otherwise be released into the environment from the ocean or be prevented from being absorbed by the ocean. The embodiments here thus have a reduced impact on the natural carbonate cycle when scaled up. Moreover, the embodiments have a reduced impact on sea life that depends on calcium and magnesium, such as coral reef and shellfish.

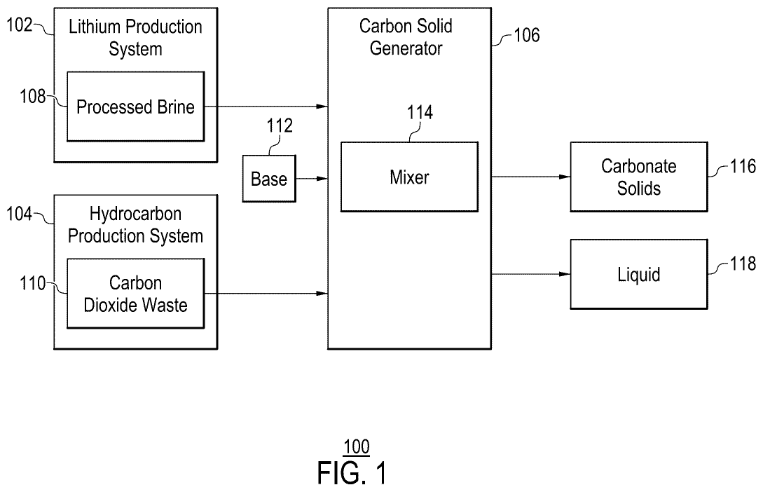

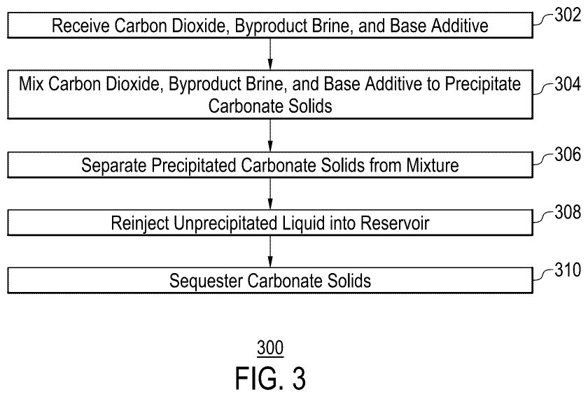

Referring now to FIG. 1, an apparatus 100 for the removal of lithium from a lithium containing brine is provided. In various embodiments, the apparatus 100 is used to implement the method 300 of FIG. 3.

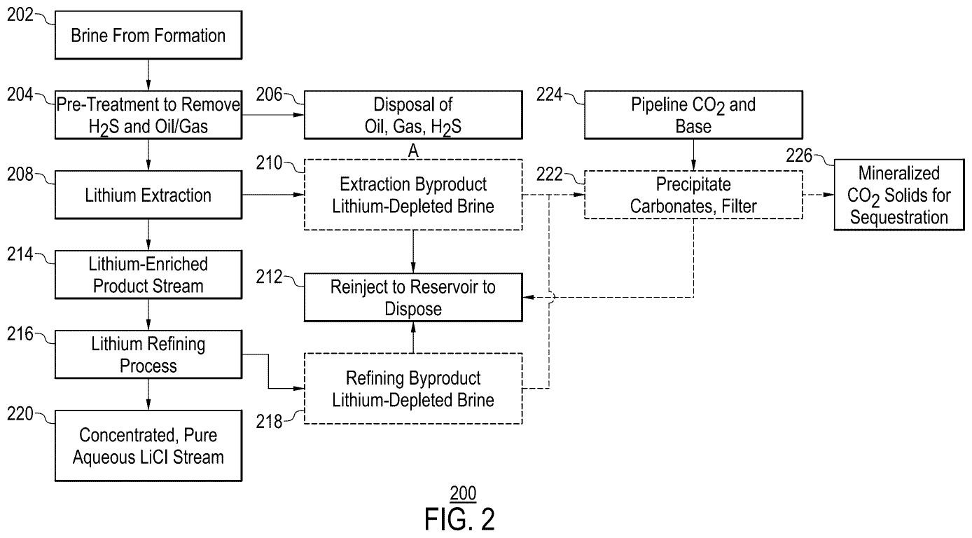

In various embodiments, a lithium production system 102 and hydrocarbon production system 104 are coupled to a carbonate solid generator 106, which may include a mixer 114. The lithium production system 102 may receive input fresh brine containing lithium and other metals provided via a well or other source and output a processed brine 108. For example, the fresh brine received from well may be a deep subsurface brine. As discussed in greater detail in FIG. 2, the lithium production system 102 may process brine via a brine pre-treatment unit may then generally pretreat the brine to produce a pretreated brine. The pretreated brine may then be processed via lithium extraction and lithium refining processes to generate processed brine 108. This processed brine 108 may be a lithium-depleted brine that includes various divalent ions, such as metal cations. For example, processed brine 108 may include calcium, magnesium, strontium, and barium, among other divalents. In various embodiments, the processed brine 108 is sent to the carbonate solid generator 106 for use in the generation of carbonate solids.

In various embodiments, a hydrocarbon production system 104 produces carbon dioxide waste as a byproduct of hydrocarbon production. In some embodiments, the carbon dioxide waste 110 may alternatively or additionally be from a pipeline. The carbon dioxide waste 110 is sent to the carbonate solid generator 106 to be converted into carbonate solids 116. A byproduct of the creation of the carbonate solids 116 is liquid 118 containing waste brine. Disposal of the liquid 118 may include reinjecting the liquid 118 to the subsurface, such as a source aquifer.

In various embodiments, a base 112 is provided to the carbonate solid generator 106 along with the processed brine 108 and carbon dioxide waste 110. In some embodiments, the base additive may be generated using bipolar electrodialysis or by electrolysis, such as by a chlor-alkali process. When adding base, the pH may not initially increase because the mixture will react to drive the chemistry to form CaCO₃, etc. However, eventually the pH will increase and when it does, the final value should be above a pH of 6, with preference for pH values of 8 or 9 and above. In various embodiments, NaHCO₃, KHCO₃ or (NH₄)₂CO₃ will always be formed as by-product when contacting base with the brine and CO₂ flue gas. In some embodiments, NaHCO₃ is precipitated as a separate product in a separate process step. In various embodiments, magnesium and calcium precipitates may be formed by recycling part of the NaHCO₃, KHCO₃ or (NH₄)₂CO₃ solutions back into the frontend of the CO₂ capture process. In some embodiments, a carbonate depleted brine that is used as an electrolyte for the base additive is generated through conventional electrolysis. For example, a chlor-alkali process or water electrolysis may be used to produce a base, hydrogen and bromine/chlorine or oxygen.

It is to be understood that the block diagram of FIG. 1 is not intended to indicate that the apparatus 100 is to include all of the components shown in FIG. 1. Rather, the apparatus 100 can include fewer or additional components not illustrated in FIG. 1 (e.g., additional streams, products, sources of brine or carbon dioxide waste, or additional processing units, etc.). For example, although described with respect to a lithium extraction process, the apparatus 100 may similarly be implemented with respect to a bromine extraction process.

FIG. 2 is a schematic diagram of a process 200 for sequestration of carbon dioxide using a brine. In various embodiments, the apparatus is used to implement the method 300 of FIG. 3. The process 200 includes, at block 202, receiving a brine from a formation.

At block 204, a brine pre-treatment unit pretreats the brine to remove hydrogen sulfide (H₂S) and hydrocarbons, such as oil and gas. In various embodiments, the brine pre-treatment may include the use of various technologies. For example, in some embodiments, the brine pre-treatment pretreats the fresh brine to remove vapor, solids, and organics from the output stream. For example, the vapor can include water vapor as well as other gases, such as methane, ethane, propane, carbon dioxide, and nitrogen, among other gases. In various examples, solids can include larger particles, such as solidified sulfates, phosphate, carbonates, silicas, sands, bits of rock, dirt, etc. In various examples, the organics can include methane, ethane, propane, butanes, pentanes, hextanes, heplanes-plus, carbon dioxide, hydrogen sulfide, pentanes-plus, etc. In some embodiments, the brine pre-treatment includes the use of a sparging tank. For example, a sparging tank may be used by controlling the amount of air injected into the sparging tank to vary the composition of the brine 202. In particular, the air is used to knockout iron, silica, and entrained gas in the brine 202 via chemical reactions. In some examples, the exact rate of air injection and vessel size of the of the sparging tank can be optimized based on the target composition of the brine 202. In some embodiments, the brine pre-treatment includes the use of a three-phase separator. For example, the three-phase separator can remove gases and solids from the brine 202. In some embodiments, the brine pre-treatment includes a desanding. For example, a desander may use a cyclone and centrifugal force to separate larger solids from brine droplets. Such larger solids may include various larger particles, such as sand or bits of rock on the scale of micrometers in size. In some embodiments, the brine pre-treatment includes a de-oiling. For example, a de-oiling cyclone can perform an additional cyclone removal for more trace oil from the brine 202. In various embodiments, such disposed trace oils include acetate, propionate, glycolate, and/or formate, among other potential trace oils.

At block 206, the oil, gas, and hydrogen sulfide (H₂S) are disposed of. For example, the oil, gas, and hydrogen sulfide may be disposed of in any suitable manner.

At block 208, a lithium extraction process is executed. For example, a sorbent is used to selectively extract lithium from the pretreated brine. In various embodiments, the lithium extraction process filters the pretreated brine into a lithium-rich brine. In some embodiments, the lithium extraction is a direct lithium extraction (DLE). The lithium extraction processes the pretreated brine to increase both the ratio of lithium to impurities and the lithium concentration. In various embodiments, regardless of the technique and materials used, the lithium extraction is accomplished by swapping lithium out of the source brine into a fresh water stream.

The lithium extraction process produces two streams: a lithium-rich stream that is fed into the second part of the lithium production process to be refined and an extraction byproduct lithium-depleted brine 210 that is disposed of. Currently, such a stream of lithium-depleted brine 210 is reinjected underground into formations as shown at block 212. In various embodiments, this lithium-depleted brine 210 can instead be utilized for carbon sequestration. An example composition of streams with ranges of species of interest that could occur in this lithium poor stream are given in Table 1.

TABLE 1
Example Brine Composition Ranges

| | |
|---|---|
| Extraction | Refining Waste streams |

| | DLE reject | NF reject | IX Regen |
|---|---|---|---|
| Element | (mg/L) | (mg/L) | (mg/L) |
| Ba | 500-5,000 | 1-1000 | 50-1000 |
| Ca | 15,000-45,000 | 100-15,000 | 1000-10,000 |
| Mg | 500-5,000 | 10-2,000 | 100-2000 |
| Sr | 500-5,000 | 10-1,000 | 50-1000 |
| Li | <100 | 200-2,000 | <500 |

At block 216, a lithium refining process is executed. For example, the refining process may be a second part of a process for lithium production from deep brines. In various embodiments, the lithium refining process 216 includes several different processes and recycle loops to recover as much lithium as possible and produces several waste streams. For example, some of the waste streams of interest are those deriving from a nanofiltration (NF) unit and from the regeneration of an ion-exchange (IX) unit. In various embodiments, there may be some amount of impurities that remain in the lithium rich water stream from the lithium extraction process 208. For example, no material and technique that can perfectly select for lithium may exist. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities. Therefore, in various embodiments, a nanofiltration can remove some remaining impurities into a nanofiltration waste stream that forms part of refining byproduct lithium-depleted brine 218. In various embodiments, a lithium rich water stream 214 from the lithium extraction process may be processed through any number of nanofilters to remove any variety of ions. On the permeate side of a nanofiltration unit that is sent to an ion exchange unit, monovalents such as sodium, lithium and potassium are allowed to go through, such that the nanofiltration waste stream is very low in these monovalents and really high in divalents. In various embodiments, the nanofiltration is configured to remove solids from nanometer sized ions dissolved in solution. For example, each of any number of nanofilters may include nano-sized holes through which the brine is passed at a certain flux rate and a certain pH, both of which may depend on the composition of the lithium rich water stream. For example, a stream having high amounts of boron may be processed with a different pH than a stream having low amounts of boron. Similarly, a stream with high amounts of impurities may be processed at a higher flux in order prevent scaling. The nanofiltration waste stream may have high concentrations of divalents. For example, the output nanofiltration waste stream may include some lithium, along with higher concentrations of divalents such as calcium and magnesium, that may otherwise have been returned to a well, but are instead recycled as described herein. For example, the nano-filtering of a lithium rich water stream with 600 PPM calcium may result in a nanofiltration waste stream with a concentration of calcium in the range of 4,000 to 8,000 PPM. In some embodiments, the nanofiltration also generates a filtered stream that is sent to the ion exchange unit for further removal of impurities.

In various embodiments, the ion exchange process can be used to interchange of one species of ion present in an insoluble solid with another of like charge present in a solution surrounding the solid. In various embodiments, the insoluble solid is a resin containing a particular ion on its surface. In one embodiment, the resin has sodium (Na+) ions along its surface. In various embodiments, the ions on the resin have higher affinity for divalents, as well as trivalents such as iron ions (Fe+++). In some embodiments, the ion exchange is used to remove divalents and replace them with sodium ions. In one embodiment, the brine flows over the resin and divalents are swapped for sodium ions in the output brine. In various embodiments, the resin-based bed hits saturation and is taken offline to regenerate the resin. Thus, in various embodiments, multiple ion exchange beds are used to allow for continuous operations. In some embodiments, the ion exchange beds may include a resin specifically configured for boron and another resin specifically configured for divalents. In some embodiments, the output of the ion exchange is sent for further filtration at the reverse osmosis unit, or any other suitable additional filters.

The outputs of the lithium refining process 216 may thus be a concentrated, pure aqueous lithium chloride stream 220 and the refining byproduct lithium-depleted brine 218 that includes byproducts of nanofiltration, ion exchange, or any combination thereof. In various embodiments, the lithium chloride stream 220 is within the range of 5-50% lithium chloride by weight. In some embodiments, the refining byproduct lithium-depleted brine 218 can be disposed be reinjection to a reservoir at block 212. A few sample waste stream compositions with ranges of species of interest that may occur in these waste streams are given in Table 1.

At block 222, a precipitation process receives carbon dioxide and base 224, which is mixed with the extraction byproduct lithium-depleted brine 210 or the refining byproduct lithium-depleted brine 218, or both, to precipitate various mineralized carbon dioxide solids for sequestration 226. In various embodiments, the base is used to raise the pH of the mixture. For example, the source of base may derive from purchased caustic such as sodium hydroxide (NaOH) or potassium hydroxide (KOH) or calcium hydroxide (Ca(OH)₂). In some embodiments, the base is locally generated at a plant through bipolar electrodialysis. The use of bipolar electrodialysis to generate base provides an advantage because bipolar electrodialysis also produces a stream of acid that can be used in the lithium refining process 216. In the case where bipolar electrodialysis is used, the feed for the lithium refining process 216 may be any stream of water that contains NaCl up to 25% by weight.

In various embodiments, the carbon dioxide is derived from any number of waste streams. For example, the waste streams may be from carbon capture from point sources, such as energy production sources, industrial point sources, CO₂ removal from natural gas production sources, or from other sources such as a direct air capture or ocean capture plants, or any other source of carbon dioxide. Examples of energy production sources include natural gas combined cycle turbines or coal flue gases. Examples of industrial point sources include steel or cement plant flue gases.

As described above, upon mixing the carbon dioxide and base 224 at block 222, the extraction byproduct lithium-depleted brine 210 and/or the refining byproduct lithium-depleted brine 218 components, a mixture of carbonate minerals may precipitate from the reaction mixture. For example, these precipitated carbonate minerals may include calcium carbonate (CaCO₃); magnesium carbonate (MgCO₃), strontium carbonate (SrCO₃), and/or barium carbonate (BaCO₃) along with some byproduct magnesium hydroxide (Mg(OH)₂)). In various embodiments, these solids are then separated from the reaction mixture. For example, the mineralized carbon dioxide solids 226 can be separated from the mixture using filtration, decantation, centrifugation, or any other suitable manner. The carbon dioxide solids 226 are then stored. In some embodiments, the liquid from the reaction will need to be disposed of such as by reinjection back into the deep brine formation at block 212.

It is to be understood that the block diagram of FIG. 2 is not intended to indicate that the process 200 is to include all of the components shown in FIG. 2. Rather, the process 200 can include fewer or additional components not illustrated in FIG. 2 (e.g., additional streams, products, or additional processing, etc.). For example, the process may further include reverse osmosis, lithium concentration, and lithium carbonate reaction, and product washing, and product drying and packaging processes that further process the concentrated, pure aqueous lithium chloride stream 220. In addition, although described with respect to a lithium extraction process, the process 200 may similarly be implemented with respect to a bromine extraction process.

FIG. 3 is a process flow diagram of a method 300 for sequestering carbon dioxide. In various embodiments, the method 300 may be implemented using the apparatus 100 of FIG. 1.

At block 302, carbon dioxide, a byproduct brine, and a base additive is received. In various embodiments, the byproduct brine is a lithium/bromine extraction byproduct, a lithium/bromine refinement byproduct, or any combination thereof. For example, the byproduct brine may be a byproduct of an ion exchange unit. The byproduct brine may be a byproduct of a membrane liquid separation technology such as a nanofiltration unit or a reverse osmosis unit. In various embodiments, the carbon dioxide is a byproduct of an energy production point source. In some embodiments, the carbon dioxide is a byproduct of an industrial point source. In some embodiments, the carbon dioxide is produced from carbon dioxide removal from a natural gas production source. In some embodiments, the carbon dioxide is from a direct air capture or ocean capture plant. In various embodiments, the base additive comprises sodium hydroxide, potassium hydroxide, or calcium hydroxide, or any combination thereof. In some embodiments, the base additive is generated through bipolar electrodialysis or by electrolysis, such as by a chlor-alkali unit.

At block 304 the carbon dioxide, the byproduct brine, and the base additive is mixed to precipitate carbonate solids. For example, the carbon dioxide, the byproduct brine, and the base additive may be mixed in any suitable reactor.

At block 306, the carbonate solids are separated from the mixture. For example, the carbonate solids and other solids may be separated from the mixture via filtration, decantation, centrifugation, or any other suitable manner. The solids are then stored for sequestration.

At block 308, unprecipitated liquid of the mixture is reinjected back into a reservoir. For example, the reservoir may be the source of the byproduct brine or any other suitable reservoir.

At block 310, the carbonate solids are sequestered. For example, in some embodiments, the carbonate solids are sequestered in cement. In some embodiments, the carbonate solids are sequestered in a landfill.

The process flow diagram of FIG. 3 is not intended to indicate that the processes of the method 300 are to be executed in any particular order, or that all of the processes of the method 300 are to be included in every case. Additionally, the method 300 can include any suitable additional processing of the brine.

### Embodiments of Present Techniques

In one or more embodiments, the present techniques may be susceptible to various modifications and alternative forms, such as the following embodiments as noted in paragraphs 1 to 25:
1. An apparatus for carbon sequestration, including: a carbonate solid generator to: receive carbon dioxide, a byproduct brine, and a base additive; mix the carbon dioxide, the byproduct brine, and the base additive to precipitate a carbonate solid; separate the carbonate solid from the mixture; and sequester the carbonate solid.
2. The apparatus of paragraph 1, where the byproduct brine includes a byproduct of a lithium extraction unit or a bromine extraction unit.
3. The apparatus of any of paragraphs 1 and 2, where the byproduct brine includes a byproduct of a lithium refining unit or a bromine refining unit.
4. The apparatus of paragraph 3, where the byproduct brine is a byproduct of a nanofiltration unit or a reverse osmosis unit.
5. The apparatus of paragraph 3, where the byproduct brine is a byproduct of an ion exchange unit.
6. The apparatus of any of paragraphs 1-5, where the byproduct brine includes a byproduct of a lithium or bromine extraction unit and a byproduct of a lithium or bromine refining unit.
7. The apparatus of any of paragraphs 1-6, where the carbon dioxide is a byproduct of an energy production point source.
8. The apparatus of any of paragraphs 1-7, where the carbon dioxide is a byproduct of an industrial point source.
9. The apparatus of any of paragraphs 1-8, where the carbon dioxide is produced from carbon dioxide removal from a natural gas production source.
10. The apparatus of any of paragraphs 1-9, where the carbon dioxide is from a direct air capture or ocean capture plant.
11. The apparatus of any of paragraphs 1-10, where the base additive includes sodium hydroxide, potassium hydroxide, or ammonium hydroxide.
12. The apparatus of any of paragraphs 1-11, where the base additive is generated through electrolysis.
13. The apparatus of any of paragraphs 1-12, where the base additive is generated through bipolar electrodialysis.
14. The apparatus of any of paragraphs 1-13, where a carbonate depleted brine that is used as an electrolyte for the base additive is generated through conventional electrolysis.
15. The apparatus of any of paragraphs 1-14, where co-production of sodium bicarbonate (NaHCO₃) is minimized or suppressed.
16. The apparatus of any of paragraphs 1-15, where the byproduct brine includes a composition of: barium in a range of 500-5,000 milligrams/liter (mg/L); calcium in a range of 15,000-45,000 mg/L; magnesium in a range of 500-5,000 mg/L; strontium in a range of 500-5,000 mg/L; and lithium in a concentration of less than 100 mg/L.
17. The apparatus of any of paragraphs 1-15, where the byproduct brine includes a composition of: barium in a range of 1-1000 milligrams/liter (mg/L); calcium in a range of 100-15,000 mg/L; magnesium in a range of 10-2,000 mg/L; strontium in a range of 10-1,000 mg/L; and lithium in a range of 200-2,000 mg/L.
18. The apparatus of any of paragraphs 1-15, where the byproduct brine includes a composition of: barium in a range of 50-1,000 milligrams/liter (mg/L); calcium in a range of 1000-10,000 mg/L; magnesium in a range of 100-2,000 mg/L; strontium in a range of 50-1,000 mg/L; and lithium of less than 500 mg/L.
19. A method of sequestering carbon, including: receiving captured carbon dioxide, a byproduct brine, and a base additive; mixing the dioxide, the byproduct brine, and the base additive to precipitate a carbonate solid; separating the carbonate solid from the mixture; and sequestering the carbonate solids.
20. The method of paragraph 19, including reinjecting the liquid of the separated mixture back into a reservoir.
21. The method of any of paragraphs 19-20, including generating the base additive using bipolar electrodialysis.
22. The method of any of paragraphs 19-21, including generating the base additive through electrolysis.
23. The method of any of paragraphs 19-22, including generating carbonate depleted brine used as an electrolyte for the base additive through conventional electrolysis.
24. The method of any of paragraphs 19-23, where sequestering the carbonate solids includes sequestering the carbonate solids in cement.
25. The method of any of paragraphs 19-24, where sequestering the carbonate solids includes sequestering the carbonate solids in a landfill.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. An apparatus for carbon sequestration, comprising:
a carbonate solid generator to:
receive carbon dioxide, a byproduct brine, and a base additive;
mix the carbon dioxide, the byproduct brine, and the base additive to precipitate a carbonate solid;
separate the carbonate solid from the mixture; and
sequester the carbonate solid.

2. The apparatus of claim 1, wherein the byproduct brine comprises a byproduct of a lithium extraction unit or a bromine extraction unit.

3. The apparatus of claim 1, wherein the byproduct brine comprises a byproduct of a lithium refining unit or a bromine refining unit.

4. The apparatus of claim 3, wherein the byproduct brine is a byproduct of a nanofiltration unit or a reverse osmosis unit.

5. The apparatus of claim 3, wherein the byproduct brine is a byproduct of an ion exchange unit.

6. The apparatus of claim 1, wherein the byproduct brine comprises a byproduct of a lithium or bromine extraction unit and a byproduct of a lithium or bromine refining unit.

7. The apparatus of claim 1, wherein the carbon dioxide is a byproduct of an energy production point source.

8. The apparatus of claim 1, wherein the carbon dioxide is a byproduct of an industrial point source.

9. The apparatus of claim 1, wherein the carbon dioxide is produced from carbon dioxide removal from a natural gas production source.

10. The apparatus of claim 1, wherein the carbon dioxide is from a direct air capture or ocean capture plant.

11. The apparatus of claim 1, wherein the base additive comprises sodium hydroxide, potassium hydroxide, or ammonium hydroxide.

12. The apparatus of claim 1, wherein the base additive is generated through electrolysis.

13. The apparatus of claim 1, wherein the base additive is generated through bipolar electrodialysis.

14. The apparatus of claim 1, wherein a carbonate depleted brine that is used as an electrolyte for the base additive is generated through conventional electrolysis.

15. The apparatus of claim 1, wherein co-production of sodium bicarbonate (NaHCO₃) is minimized or suppressed.

16. The apparatus of claim 1, wherein the byproduct brine comprises a composition of:
barium in a range of 500-5,000 milligrams/liter (mg/L);
calcium in a range of 15,000-45,000 mg/L;
magnesium in a range of 500-5,000 mg/L;
strontium in a range of 500-5,000 mg/L; and
lithium in a concentration of less than 100 mg/L.

17. The apparatus of claim 1, wherein the byproduct brine comprises a composition of:
barium in a range of 1-1000 milligrams/liter (mg/L);
calcium in a range of 100-15,000 mg/L;
magnesium in a range of 10-2,000 mg/L;
strontium in a range of 10-1,000 mg/L; and
lithium in a range of 200-2,000 mg/L.

18. The apparatus of claim 1, wherein the byproduct brine comprises a composition of:
barium in a range of 50-1,000 milligrams/liter (mg/L);
calcium in a range of 1000-10,000 mg/L;
magnesium in a range of 100-2,000 mg/L;
strontium in a range of 50-1,000 mg/L; and
lithium of less than 500 mg/L.

19. A method of sequestering carbon, comprising:
receiving captured carbon dioxide, a byproduct brine, and a base additive;
mixing the dioxide, the byproduct brine, and the base additive to precipitate a carbonate solid;
separating the carbonate solid from the mixture; and
sequestering the carbonate solids.

20. The method of claim 19, comprising reinjecting the liquid of the separated mixture back into a reservoir.

21. The method of claim 19, comprising generating the base additive using bipolar electrodialysis.

22. The method of claim 19, comprising generating the base additive through electrolysis.

23. The method of claim 19, comprising generating carbonate depleted brine used as an electrolyte for the base additive through conventional electrolysis.

24. The method of claim 19, wherein sequestering the carbonate solids comprises sequestering the carbonate solids in cement.

25. The method of claim 19, wherein sequestering the carbonate solids comprises sequestering the carbonate solids in a landfill.
